(19) United States
(12) Patent Application Publication
(10) Pub. No.: US 2024/0373855 A1
(43) Pub. Date: Nov. 14, 2024

(54) ANTIBACTERIAL OR ANTIVIRAL SHEET

(71) Applicant: Tadashi FUJIMOTO, Yamaguchi (JP)

(72) Inventor: Tadashi FUJIMOTO, Yamaguchi (JP)

(21) Appl. No.: 18/292,824

(22) PCT Filed: Apr. 8, 2022
(86) PCT No.: PCT/JP2022/017387

§ 371 Date: Jan. 26, 2024

(30) Foreign Application Priority Data
Jul. 29, 2021 (JP) 2021-124315

(51) Int. Cl. A01N 59/06; A01N 25/34; A01P 1/00

(52) U.S. Cl. CPC A01N 59/06; A01N 25/34; A01P 1/00

(57) ABSTRACT

Provided is an antibacterial or antiviral sheet molded from a fiber sheet carrying shikkui particles and an alkaline indicator.

### TECHNICAL FIELD

The present invention relates to an antibacterial or antiviral sheet that has excellent long-lasting antibacterial or antiviral properties and can prevent skin troubles caused by wearing a mask for a long period of time.

### BACKGROUND ART

In recent years, people have been required to wear masks to prevent respiratory infections such as SARS, a new coronavirus infection, and influenza. Skin troubles such as facial roughness and acne often occur due to the influence of the increased number of situations in daily life where wearing masks is mandatory.

This problem is caused by bacteria from exhaled breath or droplets that adhere to the inside of the mask due to wearing of the mask for a long period of time or reusing of the mask, with the bacteria entering areas around the mouth that are damaged due to dry skin or abrasions between the mask and skin, or with the bacteria growing at pore outlets due to restriction of discharge from the pores by wearing the mask.

Patent Document 1 discloses that a mask is treated with magnesium and calcium hydroxides obtained by partially hydrating dolomite after firing so as to impart antiviral properties. These antiviral properties are due to an antioxidant effect of hydroxyl radicals.

However, no consideration was given to the sustainability of the antibacterial or antiviral properties in the inside of the mask. If a person coughs or sneezes while wearing a mask, exhaled breath or droplets will stay inside the mask. Considering that masks are usually used for about 8 hours, there is a concern that the alkaline activity will decrease over time, and skin roughness will progress due to mask contamination caused by bacteria and the like. In addition, even when the alkaline activity is lost over time, it is impossible to visually observe the activity. Therefore, there is a possibility that a mask whose alkaline activity has been deactivated may be continuously used. In addition, in this case, the viruses that have entered the internal space of the mask as air flows in through the gap between the mask and a part of the face that cannot be necessarily fully covered by the mask will remain. Furthermore, in a case where a patient suffering from a contagious disease or the like uses a mask, viruses attached to the patient's breath or droplets will remain in the internal space of the mask.

Furthermore, particles obtained by crushing minerals such as dolomite contain calcium hydroxide. However, although the fiber sheet carrying dolomite particles as described in Patent Document 1 initially exhibits a strong alkaline activity, the alkaline activity rapidly decreases over time and does not exhibit sufficient alkaline activity after 8 hours of use, for example. This is thought to be due to the fact that, for example, the dolomite particle diameter is too small and the amount of slaked lime carried is not sufficient.

In addition, it is said that consumer (general consumer) masks are worn and removed an average of about 8 times during use of the same mask in daily life. When the mask is worn and removed many times in this manner, moisture derived from exhaled breath inside the mask dries, the neutralization reaction of the alkaline activity of dolomite progresses, and the reaction progresses in a direction in which the alkaline activity is deactivated. Furthermore, outdoors in winter the temperature difference between the hot and humid inside of the mask and cold outside air causes internal dew condensation, exposing the mask to adhesion of a large amount of moisture and drying associated with repetition of mask wearing and removal. In other words, consumer masks require a higher degree of alkali sustaining performance than medical masks, which are intended for continuous use in air-conditioned hospital rooms, but Patent Document 1 does not consider reduction in alkaline activity due to the number of times of mask wearing and removal

Patent Document 2 discloses an air-purifying mask in which a sheet made of an alkaline granular material or a porous molded body and impregnated with an alkaline indicator is attached to the outside of the mask. In this air-purifying mask, it is disclosed that the function of the air purifying mask can be maintained by immersing the sheet in an alkaline aqueous solution or spraying the sheet with the alkaline aqueous solution.

However, since the alkali used is in the form of an aqueous solution, the alkali component will be deactivated during a drying process after immersion unless the alkali contains particulate alkaline solids. In addition, when molding an alkaline substance with a resin, the alkaline substance is kneaded inside the resin, reducing the contact area between the alkaline substance and outside air, with result of making it difficult to efficiently purify the air. Furthermore, a large amount of indicator is required to impregnate the entire sheet. Furthermore, when used in combination with a mask, since the sheet is installed on the outside of the mask, exhaled breath or droplets are likely to remain inside the mask and cause bacterial contamination, and viruses that have entered the internal space of the mask or that are discharged with the breath or droplets of a patient suffering from a contagious disease or the like may also remain inside the mask, thereby limiting the effectiveness of the mask against contamination.

Furthermore, in Patent Document 2, dolomite is used as in Patent Document 1, and it is considered that there is a problem with a decrease in alkaline activity due to the number of times of mask wearing and removal.

Non-Patent Document 1 discloses a bactericidal effect when the pH of an alkaline aqueous solution is changed. When the number of viable bacteria is measured through dropwise addition of strongly alkaline electrolyzed water (AAW) into a medium in which several types of periodontal pathogenic bacteria have been cultured, it has become clear that when using a stock solution of AAW (pH 12.0), a strong bactericidal effect that significantly reduces the number of viable bacteria to approximately less than half in about 1 minute is exhibited and even a 50%-diluted aqueous solution of AAW (pH 11.4) also exhibits the same level of bactericidal effect as the stock solution or a slightly decreased bactericidal effect. On the other hand, a 25%-diluted aqueous solution of AAW (pH 11.1) exhibits almost no bactericidal effect.

### PRIOR ART

### Patent Document(s)

Patent Document 1: Japanese Patent No. 4621590
Patent Document 2: JP 2010-274022 A

### Non-Patent Document

Non-Patent Document 1: Regarding Bactericidal Effect of Strongly Alkaline Electrolyzed Water, Kazutaka Ogihara et al., Dental Pharmacotherapy, Japan, Vol. 15, No. 3 (1996)

### SUMMARY OF INVENTION

### Problems to be Solved by the Invention

Accordingly, an object of the present invention is to provide an antibacterial or antiviral sheet which has excellent long-lasting antibacterial or antiviral properties, and the antibacterial or antiviral activity of which can be visually observed.

### Means for Solving the Problem(s)

According to the present invention, there is provided an antibacterial or antiviral sheet formed from a sheet carrying shikkui particles and an alkaline indicator.

In the present invention, it is suitable that:
(1) a ratio (D₁/D₂) of a bulk density (D₁) measured on at least one surface of the fiber sheet to a bulk density (D₂) measured on a cross section at a depth of 55±5 μm from the surface is less than 1.0;
(2) a ratio (S₁/S₂) of a saturation (S₁) measured on at least one surface of the fiber sheet to a saturation (S₂) measured on a cross section at a depth of 55±5 μm from the surface is greater than 1.0;
(3) at least one surface of the fiber sheet is covered with a mesh body; and
(4) the alkaline indicator is thymolphthalein.

Furthermore, in the present invention, a mask containing the antibacterial or antiviral sheet, which is used to cover the nose and mouth, is provided.

Furthermore, in the present invention, there is provided a method for using a mask, in which a ratio (D₁/D₂) of a bulk density (D₁) measured on at least one surface of the fiber sheet to a bulk density (D₂) measured on a cross section at a depth of 55±5 μm from the surface is less than 1.0, and at least the surface of the fiber sheet having the bulk density (D₁) is placed on a side opposite to a side that covers the nose and mouth.

### Effects of Invention

The antibacterial or antiviral sheet of the present invention includes a fiber sheet carrying shikkui particles and an alkaline indicator and exhibits long-lasting antibacterial or antiviral properties for about 8 hours due to alkalinity exhibited by the shikkui particles carried on this fiber sheet. For example, when the antibacterial or antiviral sheet of the present invention is used in the form of a mask that is worn to cover the nose and mouth, it can prevent contamination of the inside of the mask by killing bacteria contained in exhaled breath and suppressing their growth. Accordingly, an effect of suppressing skin troubles or bad breath is exhibited.

In addition, in the antibacterial or antiviral sheet of the present invention, a fiber sheet carrying shikkui particles and an alkaline indicator can be used to determine whether the antibacterial or antiviral properties have been deactivated. That is, if an alkaline indicator causes alkali-induced discoloration, it means that antibacterial or antiviral properties are being expressed, but if that discoloration disappears, it can be seen that the alkalinity has disappeared and the antibacterial or antiviral properties have been deactivated.

Furthermore, the antibacterial or antiviral sheet of the present invention has not only antibacterial properties against bacteria but also antiviral properties against viruses, and can inactivate viruses when the sheet comes into contact with the viruses. For example, when wearing a mask containing a fiber sheet, a gap is created between the mask and the face that cannot be necessarily covered fully by the mask. When breathing in, air flows in through this gap, and when viruses enter the internal space of the mask and come into contact with the fiber sheet, they can be inactivated. In addition, when the fiber sheet comes into contact with viruses that are discharged with breath or droplets of a patient suffering from a contagious disease or the like, it is also effective in terms of infection prevention because it has the above-described same inactivation effect against the viruses.

Furthermore, the antibacterial or antiviral sheet of the present invention can also be manufactured separately from a non-woven fabric cover that is worn directly on the face (such as a so-called surgical mask or a three-fold KF94 mask), and in that case, it has the great advantage that it is manufactured completely separately from the structural standards and production line of the non-woven fabric cover and has no effect on the performance or cost of the non-woven fabric cover.

### BRIEF DESCRIPTION OF DRAWINGS

FIG. 1 is a schematic diagram of an antibacterial or antiviral sheet of the present invention.

FIG. 2 is a view illustrating the principle of antibacterial properties exhibited by shikkui particles.

FIG. 3 is a cross-sectional view taken along line X-X of the antibacterial or antiviral sheet of FIG. 1 which has a high-coloration region with a low bulk density on only one side.

FIG. 4 is a cross-sectional view taken along line X-X of the antibacterial or antiviral sheet of FIG. 1 which has a high-coloration region with a low bulk density on both sides.

FIG. 5 is a cross-sectional view of a mask using the antibacterial or antiviral sheet of the present invention together with a mesh body, an inner frame, and a non-woven fabric cover.

FIG. 6 is a cross-sectional view of a mask using the antibacterial or antiviral sheet of the present invention together with a mesh body and a non-woven fabric cover.

FIG. 7 is a cross-sectional view of a mask using the antibacterial or antiviral sheet of the present invention together with a mesh body.

FIG. 8 is a cross-sectional schematic view of exhaled breath circulation paths of the mask in FIG. 5 or 6.

FIG. 9 is a correlation graph between the bulk density and the depth position of the antibacterial or antiviral sheet.

FIG. 10 is a correlation graph between the saturation and the depth position of the antibacterial or antiviral sheet.

FIG. 11 shows surface comparison images of antibacterial or antiviral sheets with different drying methods.

FIG. 12 shows bulk density ratios and alkaline activity values after carrying out a moisture-absorbing drying test 8 times.

FIG. 13 is a correlation graph between the number of times of carrying out the moisture-absorbing drying test and the alkaline activity values.

FIG. 14 is a correlation graph between the number of repetitions of a dew condensation test and α-surface saturation.

FIG. 15 is a correlation graph between the alkaline activity values and α-surface saturation.

### MODE FOR CARRYING OUT THE INVENTION

### <Antibacterial or Antiviral Sheet>

Either a non-woven fabric or a woven fabric can be used as a fiber sheet 1, but non-woven fabrics are preferable in view of limiting the size of an opening to ensure a filter effect and breathability for respiration or exhibiting performance of shikkui particles 9.

A non-woven fabric may be obtained through a method well known per se using thermoplastic resin fibers. From a hygienic standpoint, thermally bonded non-woven fabrics, spunbond non-woven fabrics, nanofiber non-woven fabrics, spunlace non-woven fabrics, and the like that are obtained without using adhesives may be used. Spunbond non-woven fabrics are suitable in that shikkui particles 9 can be attached to the fiber surface through shikkui treatment, the fiber sheet obtained by carrying shikkui has a certain ventilation resistance, and alkaline activity is likely to be maintained. The presence of this ventilation resistance also contributes to formation of a dispersed airflow for preventing dew condensation when the fiber sheet is used in a mask containing a mesh body 40 to be described below.

In addition, examples of thermoplastic resins forming the fiber sheet 1 include olefin resins which are homopolymers or copolymers of α-olefins such as ethylene, propylene, 1-butene, 1-pentene, 1-hexene, 3-methyl-1-butene, 4-methyl-1-pentene, and 5-methyl-1-heptene; vinyl chloride resins such as polyvinyl chloride, vinyl chloride-vinyl acetate copolymers, vinyl chloride-vinylidene chloride copolymers, and vinyl chloride-olefin copolymers; fluorine resins such as polytetrafluoroethylene, polychlorotrifluoroethylene, polyvinylidene fluoride, tetrafluoroethylene-hexafluoropropylene copolymers, tetrafluoroethylene-perfluoroalkyl vinyl ether copolymers, and tetrafluoroethylene-ethylene copolymers; polyamide resins such as nylon 6 and nylon 66; and polyester resins such as polyethylene terephthalate, polybutylene terephthalate, and polytrimethylene terephthalate.

Among these, olefin resin fibers (especially polyethylene fiber and polypropylene fiber) are preferable in terms of alkali resistance, and non-woven fabrics made of polypropylene fiber are suitable in consideration of strength and durability.

In addition, hydrophilic fibers such as cotton are suitable for reducing a burden on the environment during disposal.

In addition, the fiber diameter, the fiber basis weight, and the like may be set depending on, for example, the purpose or use pattern of such fiber sheets. The thickness of a fiber sheet may be within an appropriate range depending on its use pattern, but is preferably 150 to 600 μm, more preferably 210 to 500 μm. If the thickness of the fiber sheet is smaller than 150 μm, it is impossible to carry a sufficient amount of shikkui particles 9 to maintain alkaline activity for a long period of time. On the other hand, if the thickness of the fiber sheet 1 is larger than 600 μm, handleability will not be good, and drying after carrying a shikkui slurry will take a long period of time.

Referring to FIG. 1, the fiber sheet 1 of the present invention may be in the form of a single fiber sheet or may be provided by thermally fusing strips 3, 3 for being hung directly on the ears or being fixed to an inner frame 50 to be described below. The lengths of the strips 3,3 may be set according to applications.

In the present invention, the shape of the fiber sheet 1 (rectangular in FIG. 1) is not limited as long as the fiber sheet is large enough to block a passage of exhaled breath (inhalation and exhalation). The fiber sheet 1 may have pleats to fit the nose and mouth when worn on the face.

In the present invention, the shikkui particles 9 are carried on the fiber sheet 1 used as described above. The shikkui particles 9 are impregnated into the fiber sheet 1 in the form of a slurry (kneaded material) obtained by dispersing slaked lime powder in water, and are carried on the fiber sheet 1. Slaked lime reacts with carbonic acid gas in air and becomes calcium carbonate, and therefore the slaked lime (calcium hydroxide) and calcium carbonate are present in the fiber sheet 1. That is, the alkalinity of the slaked lime exhibits antibacterial or antiviral properties, and carbonation progresses from the surface of the slaked lime particles to produce calcium carbonate. When all of the slaked lime is converted to calcium carbonate, the alkalinity disappears and antibacterial or antiviral properties are inactivated.

The above-described principle will be explained with reference to FIG. 2.

In FIG. 2, the shikkui particles 9 are carried on the entire fiber sheet 1 fixed to cover the nose and mouth. FIG. 2(A) shows a state when breathing in, and FIG. 2(B) shows a state when breathing out.

As shown in FIG. 2(A), when breathing in, some of the moisture present in the shikkui evaporates due to inflow of outside air, and therefore, the concentration of CO₂ from exhaled breath which is dissolved in the moisture increases and carbonation progresses.

The reaction at this time is expressed by the following formula as shown in FIG. 2(A).

Ca²⁺(aq)+2OH⁻(aq)+CO₂(g)→CaCO₃(s)+H₂O(l)

When breathing out, bacteria 7 contained in the exhaled breath adhere to the inner surface of the sheet as shown in FIG. 2(B). Moisture in the sheet permeates into the inside of the sheet 1 along with CO₂ in the exhaled breath. When this moisture adheres to the shikkui particles 9, the alkaline activity increases, thereby attacking the bacteria 7 attached to the inside of the fiber sheet 1 to kill the bacteria 7.

In addition, for example, when a mask containing the fiber sheet 1 is worn, a gap between the mask and the face that cannot be necessarily covered fully by the mask will be generated even if a non-woven fabric cover is used. In this case, there is a concern that viruses (not shown in the drawing) will not pass through the non-woven fabric cover during inhalation, and will enter the internal space of the mask as air flows in through the gap.

Alternatively, viruses with breathing out may be expelled from a patient with a contagious disease or the like and remain inside the mask. Even in such a case, when these viruses adhere to the fiber sheet 1, it is possible to attack and kill the viruses in the same manner as the above-described principle.

In addition, consumer masks have to be worn and removed many times. For this reason, the moisture in the fiber sheet 1 dries and evaporates every time the masks are worn and removed, and neutralization is likely to progress. However, in the antibacterial or antiviral sheet of the present invention, as shown in experimental examples to be described below, it has been confirmed that sufficient alkaline activity is sustained even after a moisture-absorbing drying test assuming multiple times of desorption is repeated 8 times.

An alkaline indicator is internally added to the above-described fiber sheet 1 to visualize the alkaline activity. For example, it has been confirmed that the fiber sheet 1 carrying the shikkui particles 9 shows a color characteristic of the alkaline indicator and exhibits alkalinity. For example, a thymolphthalein solution exhibits a blue color. Accordingly, even if the alkaline activity of the shikkui particles 9 is deactivated, the deactivation can be visually observed by the whitening of the sheet. Therefore, the fiber sheet 1 can be replaced quickly and mask contamination due to the bacteria 7 can be suppressed.

Next, a method for producing the antibacterial or antiviral sheet of the present invention will be described.

To carry the shikkui particles 9 on the fiber sheet 1, a dispersion (shikkui slurry) obtained by dispersing the slaked lime particles in water is used to impregnate the fiber sheet 1 through dipping or the like and dried. The solid content concentration of the shikkui particles 9 in the dispersion (total solid content of slaked lime and calcium carbonate) may generally be about 5 to 60 mass %, particularly about 8 to 20 mass %.

To prevent the shikkui particles 9 from falling off from the fiber sheet 1, it is desirable that a polymer emulsion be dispersed in the shikkui slurry used to carry the shikkui particles 9 as a binder. Examples of such polymer emulsions include aqueous emulsions of polymers such as an acrylic resin, a polyvinyl acetate, a polyurethane, styrene-butadiene rubber.

Regarding the D50 particle diameter of slaked lime particles used for preparation of a shikkui slurry, the extracted particle diameter D50 measured through a laser diffraction method is desirably within a range of 2 to 40 μm, particularly 3 to 20 μm. If the average particle diameter is within this range, it is possible to maintain a high moisture content when a mask is fixed near the nose and mouth for use, and for example, it is possible to exhibit sufficient alkaline activity to exhibit the antibacterial or antiviral properties for about 8 hours. If the particle diameter is too small, there is a concern that carbonation will progress rapidly and the alkaline activity will deactivated in a short period of time. In addition, even in a case where the particle diameter is too large, the alkaline activity tends to decrease.

In addition, since the shikkui particles 9 are used in this manner, it is possible to sustain the alkaline activity for a longer period of time compared to when the sheet is impregnated with only an alkaline aqueous solution.

The amount of shikkui particles 9 carried on the fiber sheet 1 (total solid content of calcium hydroxide and calcium carbonate) is desirably within a range of 1.5 to 5.0 mg/cm², particularly 2.2 to 4.2 mg/cm². If this amount is too large, there is a concern that the breathability of the fiber sheet 1 will be inhibited, and if the amount is small, the alkaline activity that exhibits antibacterial or antiviral properties will naturally become low. In addition, the duration of the antibacterial or antiviral properties due to the alkaline activity will also be shortened.

The amount of the shikkui particles 9 carried on the fiber sheet 1 is calculated from the following equation using a mass W₀ and a mass W₁ of a fiber sheet obtained by impregnating a non-woven fabric with an area A₀ with a shikkui slurry and drying it. The ratio of the shikkui particles 9 to the total solid content in the shikkui slurry is defined as R₁.

Amount of shikkui carried (mg/cm²)=(W₁−W₀)×R₁/A₀

Furthermore, an alkaline indicator is formulated with the above-described shikkui slurry to visualize the alkaline activity. Accordingly, as mentioned above, even if the alkaline activity of the shikkui particles 9 is deactivated, the deactivation can be visually observed by whitening. Therefore, the fiber sheet 1 can be replaced quickly and contamination inside the mask due to the bacteria 7 can be suppressed.

In addition, since the dispersion permeates into the fiber sheet 1 through immersion, the entire fiber sheet 1 is colored by the indicator. As the aqueous solution penetrates, the shikkui particles 9 are also dispersed throughout the sheet.

As this alkaline indicator, well-known indicators such as a thymolphthalein solution, a phenolphthalein solution, a bromothymol blue solution, a bromocresol green-methyl red solution, a methyl red-methylene blue solution, and neutral red-bromothymol blue solution can be used. It is preferable to use a thymolphthalein solution because it has a blue color that is easy on the eyes and gives a sense of cleanliness and is stable even when dried with hot air at high temperatures.

When using such an alkaline indicator, it is suitable to mix a solution in which this alkaline indicator is dissolved in an alcohol solvent or the like with the above-described shikkui slurry.

The amount of alkaline indicator used is sufficient as long as it is clearly visible that the fiber sheet 1 is colored in a color characteristic of the indicator when the indicator is carried on the fiber sheet together with the shikkui particles 9.

Drying after carrying the shikkui particles 9 is performed by directly applying hot air from a dryer or the like. It is preferable that the hot air be applied perpendicularly to the surface of the shikkui-treated fiber sheet 1. The temperature of the hot air is preferably 60° C. to 130° C., more preferably 90° C. to 120° C. from the viewpoint of evaporating moisture. The average wind speed of the hot air is preferably 12 to 25 m/s, more preferably 13 to 20 m/s. The drying time is preferably 1 to 7 minutes, more preferably 2 to 5 minutes.

The above-described drying with hot air is performed through applying hot air to only one surface of the shikkui-treated fiber sheet 1 or both surfaces thereof at the same time.

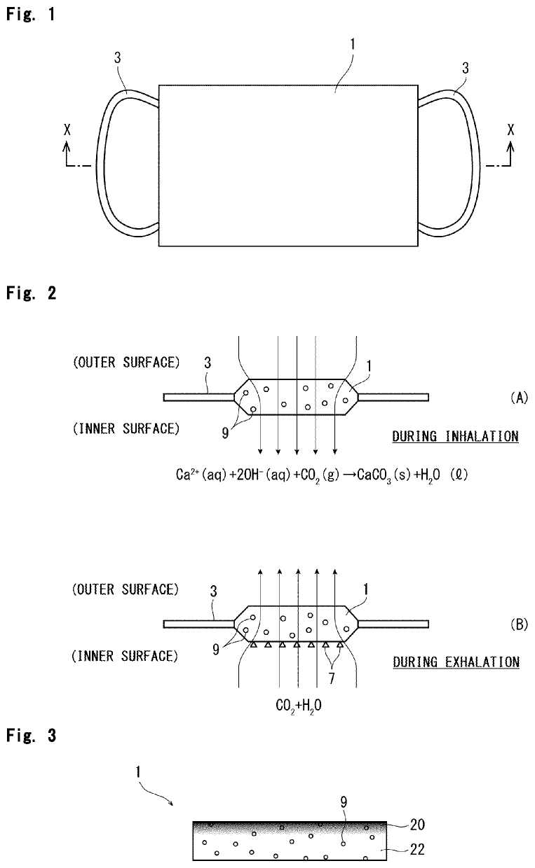

When drying is performed through applying hot air to only one surface, the fiber sheet 1 in which a high-coloration region 20 is formed on the surface as shown in FIG. 3 is obtained. The process of forming this high-coloration region 20 will be described.

When hot air is applied to the shikkui-treated fiber sheet 1, the temperature increases from the surface on the side exposed to the hot air. Therefore, moisture in the shikkui-treated fiber sheet 1 evaporates from the surface. Furthermore, as the moisture in the shikkui-treated fiber sheet moves, the dispersion solvent or the coloring component contained in the indicator moves to the surface on the side exposed to the hot air. However, since the dispersion solvent or coloring component has a high boiling point and is less likely to evaporate, they remain on the surface layer of the shikkui-treated fiber sheet 1 on the side exposed to the hot air. As a result, the high-coloration region 20 is formed as shown in FIG. 3. At the same time, since a small amount of the coloring component is present in a region other than the surface layer of the surface of the shikkui-treated fiber sheet 1 exposed to the hot air, a low-coloration region 22 is formed in the region.

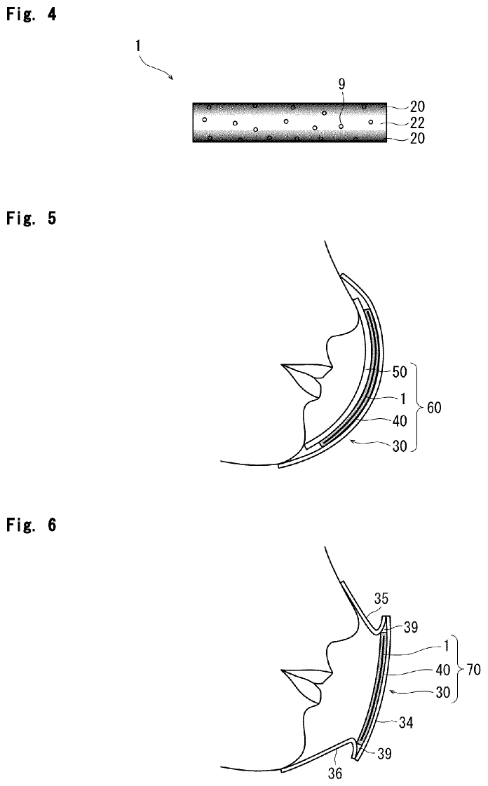

In addition, when drying is performed through applying hot air to both surfaces of the shikkui-treated fiber sheet 1 at the same time, the shikkui-treated fiber sheet 1 in which high-coloration regions 20 are formed on both surfaces as shown in FIG. 4 is obtained. The process of forming these high-coloration regions 20 is the same as above. The high-coloration regions 20 are formed on both sides of the shikkui-treated fiber sheet 1, and a low-coloration region 22 is formed in the center portion.

As shown in FIGS. 3, 4, and 10, the color of the indicator in the coloration regions becomes darker as it approaches the side exposed to the hot air, and the color gradually becomes lighter as it approaches the low-coloration region, forming a gradation pattern.

In addition, since the shikkui particles 9 have a certain size and mass and are carried on the fiber sheet 1, they do not move as accompanied with movement of moisture due to evaporation even during hot air drying, but are held in a dispersed state throughout the shikkui-treated fiber sheet 1 after drying (also called dried fiber sheet 1) as shown in FIGS. 3 and 4.

The above-described high-coloration regions 20 are regions such as porous in which the dispersion solvent or the coloring component derived from the indicator is condensed and which have a high proportion of a resin derived from the component, and therefore, have a low bulk density compared to that of the low-coloration region 22. As shown in the experimental examples to be described below, this can be confirmed by comparing measurement results of the bulk density of the high-coloration regions 20 and the bulk density of the cross section of the low-coloration region 22 (the center portion of the fiber sheet 1) obtained by cutting the high-coloration regions 20 to a specific depth.

The bulk density (D₁) measured on at least one surface of the dried shikkui-treated fiber sheet 1 is preferably 0.03 to 0.3 g/cm³, more preferably 0.05 to 0.15 g/cm³. The bulk density (D₂) measured on the cross section at a depth of 55±5 μm from the surface is preferably 0.17 to 0.7 g/cm³, more preferably 0.2 to 0.6 g/cm³.

The ratio (D₁/D₂) of these two bulk densities is lower than 1.0. Furthermore, the ratio is preferably 0.1 to 0.7, more preferably 0.2 to 0.5 from the viewpoints of preventing falling off of the shikkui particles 9 of the shikkui-treated fiber sheet 1 and sufficiently exhibiting the alkaline activity. A critical region of the bulk density ratio is also confirmed in the experimental examples to be described below. In addition, in a case where the high-coloration regions 20 are formed on both sides of the dried shikkui-treated fiber sheet 1, the values measured on each surface and the cross section both satisfy the above-described bulk densities and the bulk density ratio.

The above-described cutting depth of 55±5 μm is a reference depth (and an error during cutting) for reaching the low-coloration region 22 by cutting from the surface of the fiber sheet 1 with a cutting tool or the like. By cutting the fiber sheet 1 to a depth of 55±5 μm from the surface, in a case where the fiber sheet 1 is changed to a different thickness within a preferred range defined in the present invention, the low-coloration region 22 can be reached at any thickness.

The strong coloring of the high-coloration regions 20 is due to the coloring of the indicator caused by the alkaline activity of the shikkui particles 9, and this alkaline activity is measured by measuring the pH. When the dried shikkui-treated fiber sheet 1 is immersed in distilled water and the pH of this distilled water is measured by using a pH meter, it has been confirmed that the pH is shifted to the alkaline side. In the evaluation of the alkaline activity in the experimental examples, evaluation experiments are performed by using a value obtained by subtracting 7 from a value actually measured using the pH meter as an alkaline activity value.

The above-described pH value correlates with color (saturation) shown by the alkaline indicator. For example, in the L*a*b* color space, the higher the above-described pH, the greater the color saturation (C*) of the alkaline indicator shown by the fiber sheet 1.

The saturation in the high-coloration regions 20 is higher than the saturation in the low-coloration region 22 because the coloring component derived from the indicator is condensed in the high-coloration regions 20. This can be confirmed by comparing measurement results of the saturation of the high-coloration regions 20 of the dried shikkui-treated fiber sheet 1 and the saturation of the cross section of the low-coloration region 22 (the center portion of the fiber sheet) obtained by cutting the high-coloration regions 20 to a specific depth.

The saturation (S₁) measured on at least one surface of the dried shikkui-treated fiber sheet 1 is preferably 20 to 40, more preferably 25 to 35. Moreover, the saturation (S₂) measured on the cross section at a depth of 55±5 μm from the surface is preferably 7 to 25, more preferably 9 to 15.

The ratio (S₁/S₂) of these two saturations is higher than 1.0. Furthermore, the ratio is preferably 1.2 to 2.8, more preferably 1.8 to 2.6 from the viewpoints of preventing falling off of the shikkui particles 9 of the dried shikkui-treated fiber sheet 1 and sufficiently exhibiting the alkaline activity. In addition, in a case where the high-coloration regions 20 are formed on both sides of the dried shikkui-treated fiber sheet 1, the values measured on each surface and the cross section both satisfy the above-described saturations and the saturation ratio.

Furthermore, since the coloring component derived from the alkaline indicator is condensed in these high-coloration regions 20, even if the amount of alkaline indicator used during production is small, the color change due to deactivation of the alkalinity can be reliably visually recognized.

In the low-coloration region 22, it has been confirmed that the fiber diameter on which the shikkui particles 9 are carried increases through drying with hot air. This is due to aggregation of the shikkui particles 9 through drying and convergence of the fibers associated with it, and due to an increase in interfacial tension of the shikkui particles 9 in the low-coloration region 22 accompanied by rapid movement of water, a part of the dispersion solvent, and an organic substance derived from the indicator with hot air. That is, since neutralization of the fibers carrying the shikkui particles 9 gradually progresses from the surface to the center of each of the fibers, it is thought that the increase in fiber diameter due to hot air contributed to maintaining the alkaline activity.

Furthermore, in the dried shikkui-treated fiber sheet 1, compared to a case of natural drying or heat drying without wind speed, many of the shikkui particles 9 are firmly integrated with the fibers due to rapid drying with hot air, and a dispersion solvent or a substance derived from the indicator is fixed on the fibers together with the shikkui particles 9. Therefore, the sheet becomes tough against falling off of the shikkui particles 9 due to rubbing. That is, for example, in a case where the dried shikkui-treated fiber sheet 1 is worn in the form of a mask to cover the nose and mouth, there is little risk of contact with the skin or entry into the respiratory system due to falling off of the shikkui particles 9.

The antibacterial or antiviral sheet of the present invention is preferably handled with at least one surface covered with the mesh body 40. Since the mesh body has a certain thickness and the shikkui carried thereon is prevented from coming into direct contact with the skin when the sheet is handled, the sheet can be handled safely. Preferred constitutional requirements of the mesh body 40 to be used will be described below.

### <Mask>

The antibacterial or antiviral sheet of the present invention is preferably used in a mask to cover the nose and mouth thereon. When used in a mask, the following forms can be exemplified. The present invention is not limited to these embodiments.

First, embodiments in which a non-woven fabric cover 30 is superposed on top of the fiber sheet 1 will be described.

An embodiment of a mask 60 shown in FIG. 5 has a four-piece structure including, from the face side, an inner frame 50, a mesh body 40, a fiber sheet 1 covered with the mesh body 40, and a non-woven fabric cover 30. This embodiment is an embodiment of a case in which a fabric having no three-dimensional shape is used as a base fabric 31 of the non-woven fabric cover 30. For this reason, from the viewpoint of reliably covering the nose and mouth and fixing the fiber sheet to the center portion of the non-woven fabric cover 30, it is preferable to use the inner frame 50 having a dome shape. The mesh body 40 and the fiber sheet 1 covered with the mesh body are sandwiched and fixed between the inner frame 50 and the non-woven fabric cover 30.

An embodiment of a mask 70 shown in FIG. 6 has a three-piece structure including, from the face side, a mesh body 40, a fiber sheet 1 covered with the mesh body 40, and a non-woven fabric cover 30. In this embodiment, the base fabric 31 of the non-woven fabric cover 30 has a three-dimensional shape with a three-fold structure. Since the three-dimensional shape is ensured, the inner frame 50 may be used, but it may also be omitted. The non-woven fabric cover 30 having the three-fold structure has a recess 39 formed when opened in the vertical direction. In FIG. 6, the fiber sheet 1 covered with the mesh body 40 is fitted and fixed to the recess 39.

Next, an embodiment in which no non-woven fabric cover is used will be described.

An embodiment of a mask 80 shown in FIG. 7 has a two-piece structure including, from the face side, a mesh body 40 and a fiber sheet 1 covered with the mesh body 40.

In this embodiment, the fiber sheet 1 is large enough to cover at least the nose and mouth and has strips 3, 3 for hooking around the ears. To prevent shikkui having alkaline activity from directly touching the face, it is necessary that the mesh body 40 having certain voids be provided between at least the fiber sheet 1 and the face. By hooking the strips 3, 3 around the ears, the fiber sheet 1 is fixed so as to cover the nose and mouth. At this time, pressure is applied from the fiber sheet 1 to the mesh body 40 toward the face, but it is necessary for the mesh body 40 to have such strength or thickness that the voids do not collapse even when the pressure is applied.

### <Non-Woven Fabric Cover>

The non-woven fabric cover 30 can be of any type as long as it can cover the nose and mouth, but it can be made of various materials used for the fiber sheet 1, and may have a single layer structure or a two- or more-layered structure. In addition, a commercially available non-woven fabric cover can also be used as it is. In particular, it is preferable that the material can collect viruses during inhalation, and it is preferable that the material has high particulate filtration efficiency (PFE).

The non-woven fabric cover 30 has a base fabric 31 that covers the nose and mouth. In a case where the base fabric 31 does not have a three-dimensional shape like that used in the non-woven fabric cover 30 of the mask 60, it is preferable that the base fabric 31 have pleats to fit the face. In a case where the base fabric 31 has a three-fold structure having a three-dimensional shape such as that used in the non-woven fabric cover 30 of the mask 70, the base fabric 31 is formed by thermally fusing an upper base fabric 35, a lower base fabric 36, and strips 3, 3 from above a central base fabric 34. Usually, it is stored in a three-fold state, and the upper base fabric 35 and the lower base fabric 36 are opened vertically when in use. At this time, since recesses 39 are formed in fused portions between the upper base fabric 35 and the lower base fabric 36, and the central base fabric 34, the mesh body 40 and the fiber sheet 1 are fitted and fixed to the recesses 39 to be used in the form of the mask 70. In addition, when producing a non-woven fabric cover with a three-fold structure, the mesh body 40 and the fiber sheet 1 can be sandwiched between the central base fabric 34, and the upper base fabric 35 and the lower base fabric 36 and directly thermally fused, thereby integrating the constituent members of the mask 70.

Ring-shaped strips 33, 33 that serve as ear hooks are attached to the base fabric 31. For the strips 33, 33, in addition to a ring-shaped rubber cord, a flat stretchable non-woven fabric having openings for ear hooks can be used. The pair of ring-shaped strips 33, 33 that serve as ear hooks may be made of the same material as that of the fiber sheet 1, and are fixed to the base fabric 31 through thermal fusion or the like. As a matter of course, instead of the pair of ring-shaped strips 33, 33, a single rubber band or the like can fixed to the fiber sheet 1 and passed behind the head, whereby the non-woven fabric cover 30 can be placed over the fiber sheet 1 and worn on the face.

### <Mesh Body>

It is preferable that at least one surface of the fiber sheet 1 be covered with the mesh body 40, and it is particularly preferable that both surfaces of the fiber sheet be covered therewith. Due to the presence of the mesh body 40, the fiber sheet 1 does not come into direct contact with the skin during handling, and when a mask containing the mesh body 40 is worn, direct contact between the fiber sheet 1 and the skin can be prevented, and therefore, skin roughness or the like due to alkali of the shikkui particles 9 can be prevented. In addition, if a mesh body is installed inside the fiber sheet 1, most of bacteria in exhaled breath will pass through the mesh body with low ventilation resistance and will be collected and inactivated by the fiber sheet 1, thereby suppressing the risk of multiplication of bacteria in the mesh body.

In a case of using the non-woven fabric cover 30, the mesh body 40 and the fiber sheet 1 covered with the mesh body 40 are preferably positioned in the center portion of the non-woven fabric cover 30. This is because contact with exhaled breath coming out of the nose and mouth becomes better, and the efficiency of inactivating the bacteria 7 increases.

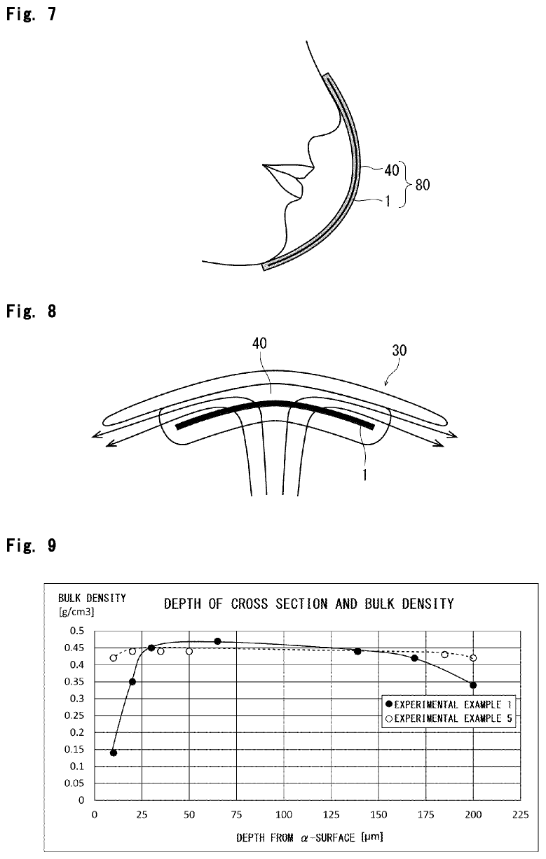

Furthermore, the mask containing the mesh body 40 can suppress generation of dew condensation water and sustain alkaline activity for a long period of time even in a usage environment such as winter where the outside air temperature is low. This is because a gap in a certain range is formed between the fiber sheet 1 and the non-woven fabric cover 30 in the mask due to the presence of the mesh body 40, with result that as shown in FIG. 8, exhaled breath containing moisture flows without staying and generates a dispersed airflow. This improves breathability and suppression of generation of dew condensation inside the mask reduces the amount of moisture staying in a certain spot, and the neutralization associated with drying during mask desorption is suppressed, allowing the alkaline activity of the shikkui particles 9 to be sustained for a longer period of time.

Even if dew condensation water is generated on the mesh body 40 and the fiber sheet 1, since the contact area between the fiber sheet 1 and the mesh body 40 is small, alkali will not transfer to the area in contact with the skin through the dew condensation water.

In addition, in a case where only one surface of the fiber sheet 1 is covered with the mesh body 40, in an embodiment where a mask contains the non-woven fabric cover 30, from the viewpoint of the above-described dew condensation suppressing effect, the mesh body 40 is preferably present at least on the non-woven fabric cover side (outside). On the other hand, in a case where a mask does not contain a non-woven fabric cover 30, the mesh body 40 is preferably present at least on the face side to prevent direct contact between the fiber sheet 1 and the skin.

The fact that the fiber sheet 1 has a certain ventilation resistance also contributes to generation of a dispersed airflow. This is because if the ventilation resistance of the fiber sheet 1 is too low, the flow rate of exhaled breath will increase at a point in time when the exhaled breath passes the non-woven fabric cover 30, the exhaled breath will leak outside the non-woven fabric cover, and a dispersed airflow will not be formed.

Furthermore, hydrophobic treatment of the mesh body 40 using a silicone water repellent or the like is effective in reducing the water content of the mesh body 40 against droplets and dew condensation water, and is therefore preferable.

As the mesh body 40, knitted fabrics, woven fabrics, non-woven fabrics, and the like can be used without limitation, and the material thereof is also not limited, but polyester or nylon knitted fabrics are preferable from the viewpoints of texture and ensuring thickness. The mesh body 40 can be used in the form of a sheet by being wound around the fiber sheet 1, or can be used in the form of a bag with the fiber sheet 1 placed therein. In addition, the thickness of the mesh body 40 is preferably 0.5 to 3.5 mm. Further, the mesh body 40 is preferably made of polyester double Raschel fabric to form gaps between the fiber sheet 1 and the non-woven fabric cover 30, and the porosity formed is preferably 85% to 98%. If the thickness or porosity of the mesh body 40 is too small, sufficient voids will not be formed, and exhaled breath that has passed through the fiber sheet 1 will not diffuse into the voids, thereby making dew condensation likely to occur. On the other hand, if the porosity is too large, there is a concern that compression rigidity will be insufficient, the mesh body will be compressed between the face and the mask and lose thickness, and the voids will collapse, which may prevent the exhaled breath from diffusing and make dew condensation likely to occur, or the fiber sheet 1 will come into contact with the skin. In addition, in a case where the thickness is too large, the space inside the mask will be compressed.

### <Inner Frame>

When using a non-woven fabric cover 30 that is difficult to secure a three-dimensional shape of a so-called surgical mask or the like, the inner frame 50 is preferably used to fix the fiber sheet 1 (or the fiber sheet 1 covered with the mesh body 40). The inner frame 50 creates a space between the dried fiber sheet 1 and the face, and direct contact between the fiber sheet 1 and the skin can be avoided, thereby preventing damage to the skin due to alkali and abrasions on the face caused by the fiber sheet 1 itself. Furthermore, since the inner frame 50 has a dome shape, it is possible to create a space around the nose and mouth, disperse exhaled breath, and effectively utilize an alkaline component of the entire sheet. Therefore, the effect of the antibacterial or antiviral properties can be sustained for a long period of time.

As the inner frame 50, various commercially available inner frames can be used and preferably have a dome shape. The material of the inner frame 50 is not limited, but polyethylene resins, silicone resins, and the like can be used. The method for fixing the fiber sheet 1 to the inner frame 50 is not particularly limited as long as the fiber sheet can be fixed thereto, but for example, the fiber sheet 1 can be fixed to the inner frame 50 by hooking the strips 3, 3 of the fiber sheet on the convex portion of the inner frame. In addition, the inner frame 50 preferably has an opening portion. Moisture and the bacteria 7 in exhaled breath pass through this opening portion and reach the fiber sheet 1. The opening proportion of the inner frame 50 is preferably 8% to 50% in view of the balance between the strength and the breathability.

When a mask containing the fiber sheet 1 is worn on the face, it is recognized that a color due to the indicator would disappear (whitening) from the center portion of the fiber sheet 1 (the above-described saturation (C*) value would decrease), and it is confirmed that CO₂ is supplied from exhaled breath and neutralization progresses.

In a case where the surface having the high-coloration region 20 with a low bulk density is formed on only one side of the fiber sheet 1, the surface having the high-coloration region 20 is preferably placed on an opposite side to a side that covers the nose and mouth (outer surface side). In the fiber sheet 1, alkali is first inactivated from the surface layer that is directly brought into contact with exhaled breath on the side that covers the nose and mouth. At this time, if the surface having the high-coloration region 20 is used for the side that covers the nose and mouth, even though the alkaline activity of the low-coloration region 22 existing on the outer surface side of the fiber sheet 1 is still in a usable state, the color of the high-coloration region 20 will disappear. This is because there is a concern that appropriate replacement timing will not be obtained.

To confirm whether the alkaline activity is sufficiently usable (degree of whitening) while using the mask, the fiber sheet 1 covered with the mesh body 40 is removed from the mask, and the degree of whitening is visually observed from above the mesh body 40.

In addition, it is generally said that the higher the color density of a colored textile product, the more susceptible it is to surface reflection, and that the more reflective the fabric, the more uniform the dark color expression will be. In the present invention, in a case where double Raschel is used as the mesh body 40 with a high reflectance, the higher the saturation of the color developed by the indicator in the fiber sheet 1, the stronger the influence of surface reflection of the mesh body 40. Accordingly, in the region with a high color saturation, the range of change in saturation due to neutralization of the alkaline activity of the fiber sheet 1 when viewed from above the mesh body 40 is reduced, and the color development when the alkaline activity is sustained is uniformized. Accordingly, it is easier to determine the sign of replacement of the fiber sheet 1 due to alkali deactivation by observing the fiber sheet 1 from above the mesh body 40 than by directly observing the fiber sheet 1 visually. That is, when the fiber sheet is colored, it means that the alkaline activity is sustained, and when the fiber sheet is white, it means that the alkaline activity has been deactivated, and the sign for replacing the fiber sheet 1 is simplified into two stages. These results have been confirmed by the experimental examples to be described below.

In addition, especially when the fiber sheet 1 is integrated with the non-woven fabric cover through fusing or the like and the fiber sheet 1 cannot be removed, light such as LED light is transmitted through a mask and the degree of whitening of the fiber sheet 1 is visually observed from a side opposite to the light source.

The antibacterial or antiviral sheet of the present invention is packaged in a nylon film or the like for storage, and is shielded from the outside air to prevent the progress of neutralization. If the sheet needs to be stored for a longer period of time, it may be packaged in an aluminum vapor deposition film.

The antibacterial or antiviral sheet of the present invention can also be used in various applications, such as protective clothing and medical gowns, which require antibacterial or antiviral properties. In particular, when an alkaline indicator is carried together with the shikkui particles 9 and dried with hot air, deactivation of alkalinity (disappearance of antibacterial or antiviral properties) can be immediately recognized by color change, and therefore, it is significantly useful in preventing bacterial contamination.

Since the antibacterial or antiviral sheet of the present invention can be produced completely separately from the non-woven fabric cover 30, it does not impair the performance of the non-woven fabric cover and does not affect the production process.

In addition, the antibacterial or antiviral sheet of the present invention can be used as a mask cover by superposing it on the non-woven fabric cover 30, thereby preventing virus contamination of the non-woven fabric cover and effectively preventing contact infection from the non-woven fabric cover (or mask cover).

### EXAMPLES

The invention will be described using the following experimental examples.

### Experimental Example 1

A fiber sheet (polypropylene spunbond non-woven fabric) cut into 50 mm×50 mm and having a basis weight of 30 g/m² and a thickness of 220 μm was used to impregnate the entire sheet with a shikkui slurry mixed with 100 parts of slaked lime (Inoue Calcium Corporation, product number: NICC5000), 200 parts of polyvinyl alcohol (manufactured by Tombow Pencil Co., Ltd., Pit Aqua) (30 parts of a solid content), and 8 parts of a 1% thymolphthalein ethanol solution (Tp) for 10 seconds to carry 2.7 mg/cm² of a shikkui solid content on the shikkui slurry. After impregnating, the sheet was clipped with a clip and fixed in the air in a room at 20° C. and 10% RH, and dried using a heat gun (Takagi Co., Ltd., heat gun HG-1450B with temperature control function) by evenly applying hot air from only one side of the sheet at 110° C. and a wind speed of 15 m/s for 5 minutes to produce dried fiber sheet A. The surface on a side on which hot air was applied was defined as an α-surface, and the surface to which hot air was not applied was defined as a β-surface.

For setting conditions for the hot air from the heat gun, a set temperature of the heat gun was used as the temperature, and the wind speed was set at a distance from an outlet where 15 m/s could be obtained using the sensor of an anemometer (Kanomax Japan Inc., Anemomaster MODEL 6006) with no resistance.

### Experimental Example 2

A dried fiber sheet B was produced by conducting an experiment under the same conditions as those in Experimental Example 1 except that the fiber sheet was dried by applying hot air to both surfaces at 110° C. and a wind speed of 15 m/s using a heat gun. Arbitrary surfaces were respectively defined as an α-surface and a β-surface.

### Experimental Example 3

A dried fiber sheet C was produced by conducting an experiment under the same conditions as those in Experimental Example 1 except that the temperature of hot air was set to 70° C. The surface on a side on which hot air was applied was defined as an α-surface, and the surface to which hot air was not applied was defined as a β-surface.

### Experimental Example 4

A dried fiber sheet D was produced in the same manner as in Experimental Example 1 except that the drying conditions were natural drying at 20° C. (room temperature) and a wind speed of 0 m/s (no wind). Arbitrary surfaces were respectively defined as an α-surface and a β-surface.

### Experimental Example 5

A dried fiber sheet E was produced in the same manner as in Experimental Example 1 except that a sheet was dried at a drying temperature of 110° C. and a wind speed of 0 m/s (no wind) using a constant temperature dryer (Yamato Scientific Co., Ltd., DNF601) without using a heat gun. Arbitrary surfaces were respectively defined as an α-surface and a β-surface.

### <Amount of Shikkui Particles Carried>

The amount of the shikkui particles carried on the fiber sheet 1 is calculated by using the mass of 162.6 mg of a fiber sheet obtained by impregnating a non-woven fabric with a mass of 75 mg and an area of 25 cm² with a shikkui slurry and drying it.

First, the ratio R₁ of the shikkui particles to the total solid content in the shikkui slurry is determined as follows.

R₁=100/(100+30)=0.77

Accordingly, the amount of shikkui carried is determined as follows.

$$Amount of shikkui carried ( mg / {cm}^{2} ) = ( {W}_{1} - {W}_{0} ) \times {R}_{1} / {A}_{0} = ( 162.6 - 75 ) \times 0.77 / 25 = 2.7 mg / {cm}^{2}$$

### <Mass>

The mass was measured in units of 0.1 mg by using a digital precision scale manufactured by Bonvision. To suppress the influence of humidity in the measurement environment, the measurement was performed under the conditions of 20° C. and 10% RH or less.

### <Thickness>

Each of the produced sheets was cut into a size of 10 mm×40 mm and sandwiched between 9 mmφ metal attachments to measure the thickness of the sheet in units of 1 μm using a dial gauge (manufactured by J&T, digital thickness gauge accuracy of 1 μm). The sheet was divided into four equal pieces in the longitudinal direction, measurement was performed at four locations, and the average value thereof was taken as a thickness of the sheet. To avoid the influence of humidity during measurement, the indoor environment was set at 20° C. and 10% RH or less.

### <Bulk Density>

Using a dried fiber sheet cut into a size of 10 mm×40 mm, a mass W_{A} and a thickness T_{A} before cutting were measured, and then the sheet was cut to a thickness of 20 μm as a guide using waterproof paper (#800), a mass WB and a thickness T_{B} after cutting were each measured, and a bulk density (D₁) was obtained through the following calculation.

$${D}_{1} = ( {W}_{A} - {W}_{B} ) / ( ( {T}_{A} - {T}_{B} ) \times 4 )$$

### <Saturation>

a*b* was measured according to the CIE 1976 L*a*b* color space (JIS Z 8781-4), and saturation was calculated. The saturation of the α-surface was set to S₁.

<Thickness, Cross-Sectional Bulk Density, and Cross-Sectional Saturation after Cutting>

The α-surface of each dried fiber sheet was cut at 55±5 μm by using waterproof paper (#800). Regarding the sheet after cutting, the thickness of the dried fiber sheet, the cross-sectional bulk density (D₂) and cross-sectional saturation (S₂) after cutting were measured in the same manner as described above.

In addition, the bulk density ratio (D₁/D₂) and the saturation ratio (S₁/S₂) were calculated from the above-described measurement values.

### <Surface Observation>

An optical microscope (Skybasic, Digital Microscope 2MP) was used to take images of both surfaces of each of the produced dried fiber sheets and the non-woven fabric before carrying shikkui.

### <Measurement of Average Fiber Diameter>

An optical microscope (Skybasic, Digital Microscope 2MP) was used to read an image of the fiber diameter at arbitrary 10 points on the β-surface magnified at a magnification of 100 times according to JIS R 7607:2000B, and an average value thereof was determined.

### <Surface Peel Test>

When a dried fiber sheet is used as a part of a mask, the outside of the dried fiber sheet comes into contact with the inside of a mesh body or a non-woven fabric cover. Therefore, rubbing occurs at the contact points while the mask is worn on the human body. If the degree of fixation of shikkui particles on the α-surface of the dried fiber sheet is low, a shikkui component will migrate to the inside of the non-woven fabric cover due to rubbing, and if the non-woven fabric cover is then worn directly on the skin, there will be a risk of alkali adhesion. In addition, peeling off of the shikkui particles involves a risk of alkali intrusion into the respiratory system.

Accordingly, to confirm the degree of fixation of shikkui on the dried fiber sheet, a surface peel test was carried out on both surfaces of the dried fiber sheet according to the peeling method of JIS K 5600-8-6. After cellophane tape was pasted on both surfaces of the produced dried fiber sheet and peeled off, each was pasted on a black plastic surface with a brightness of 40, L-values of the α-surface and β-surface were measured, and the differences in brightness between the L-values and a blank L-value obtained by simply pasting cellophane tape on black plastic were each calculated. That is, the results of this test show that the lower the degree of fixation of shikkui, the greater the peeling amount due to the cellophane tape, and the greater the difference in brightness.

<Measurement of Bulk Density and Saturation Distribution with Respect to Sheet Thickness>

For both surfaces of each dried fiber sheet with a size of 10 mm×40 mm, the thickness, cross-sectional bulk density and cross-sectional saturation after cutting were measured after each cut of approximately 20 to 30 μm. This process was repeated until the thickness of the dried fiber sheet was becoming to 140 μm or less to confirm the correlation between the bulk density and saturation with respect to the thickness of the dried fiber sheet.

### <Moisture-Absorbing Drying Test (Elution Test)>

In consumer masks, moisture is likely to evaporate from a fiber sheet because the masks are worn and removed many times, and neutralization is likely to progress compared with medical mask applications in which masks are used only once. Therefore, the power of retaining alkaline activity in a case where moisture absorption and drying were repeated was evaluated.

Each of the produced dried fiber sheet was cut into a test piece with a size of 10 mm×20 mm, and a thin coat of silylated urethane adhesive (Konishi Co., Ltd., Ultra-Versatile SU) was applied to an α-surface, which was then left at room temperature for 3 hours or longer and cured, and the α-surface was shielded. Using a cylindrical container with a diameter of 20 mm and a depth of 40 mm, the sheet with the α-surface shielded was immersed in 3.5 cc of distilled water for 10 seconds while stirring, then the fiber sheet was taken out and the pH of the distilled water was measured. The taken-out test piece was then dried naturally for 30 minutes (20° C., 10% RH). The above-described process of immersion, pH measurement, and drying was repeated 8 times, and the degree of neutralization progress due to repeated dry lacquer was evaluated. The pH meter used was Economy Type pH 20 manufactured by Apera Instruments, LLC.

The reason why the α-surface was shielded is that when the dried fiber sheet of the present invention is used inside a mask, exhaled breath or droplets containing moisture will only hit from the nose and mouth (face side), and therefore it is necessary to create an environment where moisture permeates from only one side of the sheet in a pseudo manner.

### Experimental Example 6

A test piece obtained by cutting an antiviral mask (Mochigase Co., Ltd., Barriere) in which dolomite was carried on a 200 μm thick non-woven fabric sheet into a size of 10 mm×20 mm was set to a fiber sheet F. The amount of dolomite carried on the sheet F was 1.0 mg/cm².

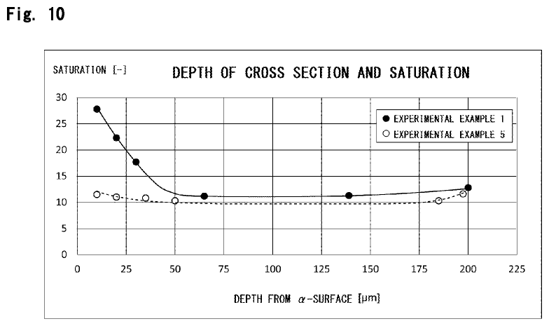

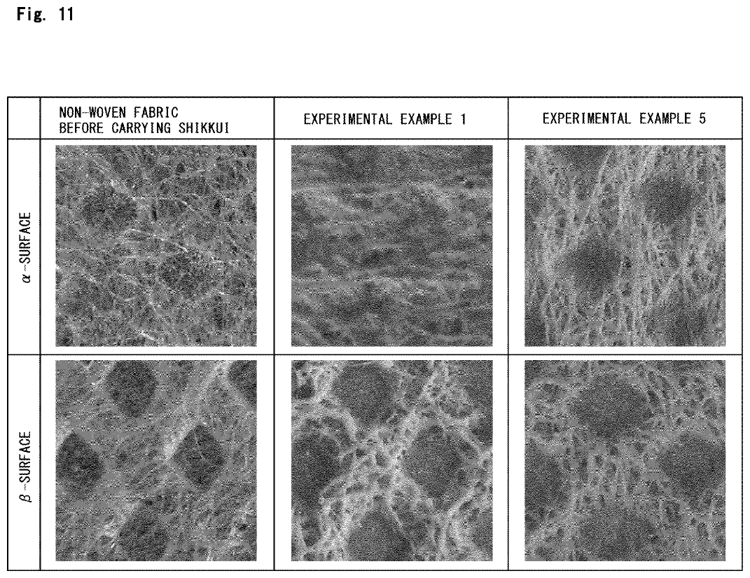

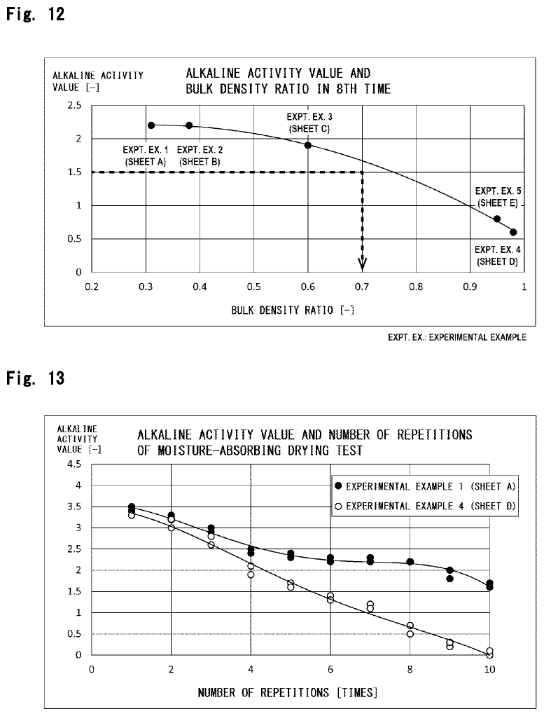

The above-described measurements and evaluations were performed on the fiber sheets A to F obtained in Experimental Examples 1 to 6. The experimental conditions and measurement results are summarized in Table 1. In addition, correlation graphs between the depth position of fiber sheets, and the bulk density and saturation are shown in FIGS. 9 and 10, results of surface observation are shown in FIG. 11, and results of alkaline activity retention test are shown in FIGS. 12 and 13. Since the amount of dolomite carried on the fiber sheet F according to Experimental Example 6 was as small as 1.0 mg/cm², a simple comparison could not be made. Therefore, the results thereof are not shown in the table and drawings, and no surface observation or measurement of the average fiber diameter was made.

TABLE 1

| | | | Experimental | Experimental | Experimental | Experimental | Experimental |
|---|---|---|---|---|---|---|---|
| | | | Example 1 | Example 2 | Example 3 | Example 4 | Example 5 |
| Experimental | Substance carried on sheet | | Shikkui | Shikkui | Shikkui | Shikkui | Shikkui |
| conditions | | | particles | particles | particles | particles | particles |
| | Carried amount [mg/cm²] | | 2.7 | 2.7 | 2.7 | 2.7 | 2.7 |
| | Thickness [μm] | | 225 | 225 | 225 | 225 | 225 |
| | Drying temperature [° C.] | | 110 | 110 | 70 | 20 | 110 |
| | Average wind | α-surface | 15 | 15 | 15 | 0 | 0 |
| | speed [m/s] | β-surface | 0 | 15 | 0 | 0 | 0 |
| Sheet | Name of produced sheet | | Sheet A | Sheet B | Sheet C | Sheet D | Sheet E |
| measurement | Measurement of | Surface bulk | 0.14 | 0.18 | 0.26 | 0.42 | 0.42 |
| results | α-surface | density (D₁) | | | | | |
| | | [g/cm³] | | | | | |
| | | Surface | 27.5 | 24.9 | 13.8 | 0.4 | 11.5 |
| | | saturation (S₁) | | | | | |
| | Measurement of | Cutting depth | 56 | 55 | 56 | 55 | 57 |
| | cross section | [μm] | | | | | |
| | after cutting | Cross-sectional | 0.45 | 0.47 | 0.44 | 0.43 | 0.44 |
| | α-surface | bulk density (D₂) | | | | | |
| | | [g/cm³] | | | | | |
| | | Cross-sectional | 12.5 | 13.2 | 11.2 | 0.4 | 10.3 |
| | | saturation (S₂) | | | | | |
| | Bulk density ratio (D₁/D₂) | | 0.31 | 0.38 | 0.59 | 0.98 | 0.95 |
| | Saturation ratio (S₁/S₂) | | 2.48 | 2.38 | 2.08 | 1.06 | 1.12 |
| | Average fiber diameter of | | 74 | — | 68 | 47 | 42 |
| | β-surface [μm] | | | | | | |
| | Difference in | α-surface | 0.1 | 0.1 | 0.3 | 0.1 | 10.1 |
| | brightness with | β-surface | 4.7 | 0.2 | 4.9 | 22.5 | 18.4 |
| | blank in surface | | | | | | |
| | peel test | | | | | | |

| | | | | | |
|---|---|---|---|---|---|
| Alkaline activity value after | 2.2 | 2.2 | 1.9 | 0.6 | 0.8 |
| eight times | | | | | |

### <Consideration of Bulk Density and Saturation Measurement Results>

Regarding the surface bulk density, for sheets A to C, the surface bulk density (D₁) is significantly lower than the cross-sectional bulk density (D₂) up to a depth of about 25 μm from the α-surface, and the surface saturation is significantly higher than the cross-sectional saturation. This is thought to be due to organic substances derived from polyvinyl alcohol (PVA) and thymolphthalein (Tp) being attracted near the surface where it is exposed to hot air, as well as to the porous structure. On the other hand, in the sheets D and E, no significant difference was observed when comparing the surface bulk density with the cross-sectional bulk density and the surface saturation with the cross-sectional saturation, and the bulk density ratio was close to 1. The reason for this is thought to be that the sheets D and E were not exposed to hot air during drying, and therefore, the evaporation rates were slower than those in the sheets A to C, and organic substances hardly moved.

In addition, between the sheets D and E, the surface saturation and cross-sectional saturation of the sheet D were significantly low. This is thought to be because it took a very long time, about 2 hours, to dry after impregnation with a shikkui slurry, and neutralization progressed during this period.

In addition, the bulk density ratio in the sheet F was about 1.0, and like the sheets D and E, it was homogeneous from the surface layer to the inside of the sheet.

### <Consideration of Surface Observation and Average Fiber Diameter Measurement Results>

The α-surface of the sheet A was in a state where it was difficult to confirm the fiber diameter due to adhesion of the organic substances derived from PVA and Tp to the fibers. The fiber diameter of the β-surface of the sheet A was relatively large, and larger than the fiber diameters of the α-surface and β-surface of the sheet E.

In the sheet B, adhesion of the substances derived from PVA and Tp was confirmed on the α-surface and β-surface, and similarly to the α-surface of the sheet A, it was difficult to confirm the fiber diameter of the sheet B. However, in the cross section at a depth of 55 μm from the α-surface, the fiber diameter was relatively large, as in the β-surface of sheet A described above.

Regarding the sheet C, adhesion of the organic substances derived from PVA and Tp was confirmed on the cross section at a depth of 25 μm from the α-surface, but the fiber diameter was relatively large in other parts similarly to the β-surface of the sheet A.

The reason why the average fiber diameter of the sheets A to C increased is thought to be due to aggregation of shikkui particles and a resulting increase in fiber convergence during the drying process with hot air. That is, it is thought that the reason is that the interfacial tension of the shikkui particles increased due to rapid movement of water and some of the organic substances derived from PVA and Tp to the α-surface side in the sheets.

On the other hand, when the cross sections of the sheets D to F were observed while changing the cutting depth, no region where a significant change in fiber diameter was observed could be confirmed.

### <Consideration of Surface Peel Test Results>

The sheets A to C had a smaller peeling amount and a smaller difference in brightness on the β-surface than the sheets D and E. This is thought to be because many of the shikkui particles of the sheets A, B, C were firmly integrated with the fibers due to rapid drying with hot air, whereas integration of the shikkui particles with the fibers was weak in the naturally dried sheet D and the sheet E without strong wind.

The α-surfaces of the sheets A to C had a porous structure, but there were substances thought to be derived from PVA and Tp attached to the surfaces, and these substances were fixed on the fibers together with the shikkui particles. For this reason, it is thought that the α-surfaces of the sheets A to C are tough against falling off of the shikkui particles due to rubbing.

A certain bulk density is required to obtain this toughness against rubbing, and it can be said that the bulk density ratio is preferably 0.1 or more, more preferably 0.2 or more.

In addition, the sheet D had a larger difference in brightness and a larger peeling amount than the sheet E on both sides. This is thought to be because the sheet D was naturally dried and the bonding force between the shikkui particles and the fibers was even weaker. Regarding the sheet F, the difference in brightness with the blank was 5.1 on the α-surface and 5.0 on the β-surface.

### <Consideration of Moisture-Absorbing Drying Test (Elution Test)>

The alkaline activity values of the sheets A to E were at the same level when the number of repetitions was 1 to 3, but after the number of repetitions of 4 to 5, the numerical values of the sheets D and E decreased significantly (refer to FIGS. 12 and 13). The shikkui particles carried on these fiber sheets are aggregates that cover non-woven fabric fibers, but regardless of the fiber diameter of the fiber sheet, the water absorption rate during immersion in water is at the same level, and water enters inside the aggregates. On the other hand, since neutralization progresses gradually from the surface of the aggregates exposed to air during drying to the inside, the sheets A to C with large fiber diameters have a small specific surface area and are advantageous in maintaining alkaline activity, and the interfacial tension of the shikkui particles caused by hot air during the production process may have contributed.

On the other hand, it is thought that the naturally dried D and the sheet E without strong wind had a significantly low alkaline activity value because strong interfacial tension between the shikkui particles did not act and the fiber diameter became thinner. In addition, regarding the sheet F, the alkaline activity value was 0.4 at the 4th time and 0 at the 8th time, indicating that the sustainability of the alkaline activity was insufficient.

<Bulk Density Ratio Determined from Moisture-Absorbing Drying Test (Elution Test) Results>

From the experimental results disclosed in Non-Patent Document 1, assuming that the pH required to kill many types of bacteria in a short period of time is 11.5, a value of the hydrogen ion concentration [H₁] at this time can be shown as follows.

[H₁]=1×10^{-11.5}

Here, when the saturated water absorption amount adhered to a 10×20 mm size test piece (sheet) with one side sealed is a maximum value when immersed in water, that is, when the hydrogen ion concentration is the lowest, the saturated water absorption amount per unit area is 2.0 mg/cm², and at this time, it is necessary to have the hydrogen ion concentration of [H₁] described above.

On the other hand, in the moisture-absorbing drying test (elution test), a 10×20 mm size test piece (sheet) is immersed in 3.5 cc of distilled water for 10 seconds. The amount of water with which the test piece comes into contact during the elution test is 3.5 cc/2 cm², and when converted to the weight of water per unit area, it is 1.8×10³ mg/cm². Since this unit water amount is on the order of 1/1000 of the above-described saturated water absorption amount, the relationship between the hydrogen ion concentrations [H₂] and [H₁] required in the elution test can be expressed as follows.

$$[ {H}_{2} ] \times 1 \times {10}^{- 3} = 1 \times {10}^{- 11.5} ( = [ {H}_{1} ] )$$

$$[ {H}_{2} ] = 1 \times {10}^{- 8.5}$$

pH=−log₁₀ 10^{-8.5} (equation for pH and ion concentration) pH=8.5

Since the alkaline activity value is a value obtained by subtracting 7 from a measured pH, it can be seen from the following equation that the reference value of the alkaline activity value is 1.5.

(Alkaline activity value)=8.5−7=1.5

The reference value of the alkaline activity is an alkaline activity value necessary to kill many types of bacteria in a short period of time.

Using this reference value of the alkaline activity value, it can be seen from the approximate curve in FIG. 12 that the bulk density ratio when the alkaline activity value is 1.5 is 0.7.

Accordingly, in conjunction with the results of the above-described surface peel test, it can be said that the bulk density ratio is preferably 0.1 to 0.7, more preferably 0.2 to 0.5.

### <Dew Condensation Test>

Moisture generated by dew condensation inside the mask, especially in winter, causes the fiber sheet to become neutral due to moisture absorption and drying when the mask is worn and removed, leading to a decline in performance due to external factors, such as droplets and respiration, other than those originated from the human body.

In this test, a device that reproduces an environment in which a mesh body is sandwiched between an antibacterial or antiviral sheet and a non-woven fabric cover and the resultant is worn on the human body was created, and the effect of dew condensation depending on the presence or absence of the mesh body was investigated. The environmental conditions were set to winter because dew condensation is likely to occur.

### Experimental Example 7

An opening with a diameter of 25 mm was made in the center portion of a lid of a lid-attached polypropylene cylindrical sealed container (Risu Kabushiki Kaisha, Clear Blue 350 ml, lid diameter 80 mm, height 110 mm), and a temperature and humidity sensor (LINKBIRD, IBS-TH1PLUS) was installed at an upper portion of the container. Water was filled to ⅔ of the container so that the temperature and humidity sensor was not immersed, and the water temperature was adjusted so that the air temperature in the upper space of the container was 26° C. to 28° C. while stirring with a magnetic stirrer. The sheet A produced in Experimental Example 1, which was cut into a circle with a diameter of 35 mm, was left at 20° C. and 10% RH for 1 hour, and the weight and saturation of the α-surface were measured. It was installed so as to cover the circular opening in the center portion of the lid of the container with the α-surface facing upward (atmospheric air side) and the β-surface facing downward (container side). Furthermore, a mesh body cut into a diameter of 70 mm (Tint Nokko Co., Ltd., Antibacterial Double Russell Mesh White) and a non-woven fabric cover (Daio Paper Corporation, Hyper Block Mask) cut into 120 mm×120 mm were superposed on top of the sheet in this order, and the lid of the container was covered with the non-woven fabric cover and fixed with a rubber band along the side surface of the container.

After exposing this device to outside air (7° C., no wind) for 40 minutes, only the sheet was taken out and its weight was measured. After measurement of the weight, it was dried at room temperature of 20° C. and 10% RH for 20 minutes. Saturation was measured after drying. The dried sheet was installed in the container again, and the same process as described above was repeated 4 times.

### Experimental Example 8

The experiment was performed in the same manner as in Experimental Example 7 except that the process of the dew condensation test was repeated 8 times.

### Experimental Example 9

The experiment was performed in the same manner as in Experimental Example 7 except that no mesh body was used.

### Experimental Example 10

The experiment was performed in the same manner as in Experimental Example 7 except that the process of the dew condensation test was repeated 8 times and no mesh body was used.

### <Calculation of Average Amount of Dew Condensation Water>

The average amount of dew condensation water was determined according to the following equation.

Amount of dew condensation water after n times=((weight of fiber sheet immediately after being taken out from container for the n-th time [mg])−(weight of fiber sheet before test [mg]))/(area of opening with diameter of 25 mm of 4.9 [cm²])

Average amount of dew condensation water after 4 times in Experimental Example 7 [mg/cm²]=average value of dew condensation water after 1 to 4 times
Average amount of dew condensation water after 8 times in Experimental Example 8 [mg/cm²]=average value of dew condensation water after 1 to 8 times

### <Calculation of Saturation or Alkaline Activity Value Maintenance Rate>

The maintenance rate was determined according to the following equation.

Maintenance rate [%]=(alkaline activity value or saturation of fiber sheet after 4 or 8 repetitions)/(alkaline activity value or saturation of fiber sheet before test)×100

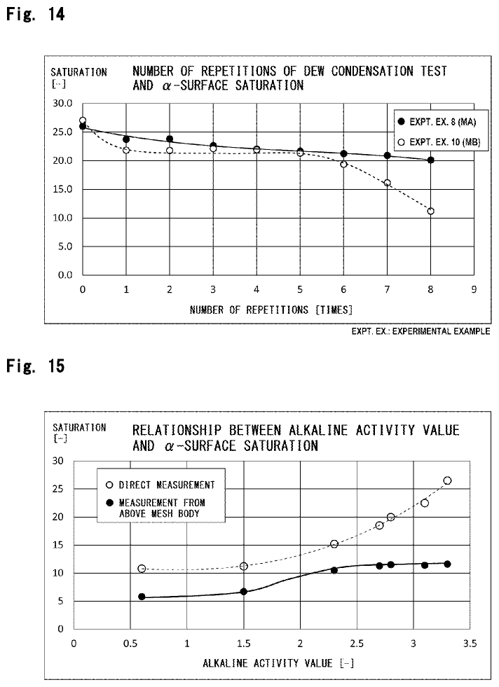

The average amount of dew condensation water was calculated for the fiber sheets obtained in Experimental Examples 7 to 10. In addition, similar to the case of Experimental Examples 1 to 5, the alkaline activity values and the saturations of the fiber sheets before and after the test were measured. The results are shown in Table 2. Furthermore, the relationship between the number of repetitions and the α-surface saturation is shown in FIG. 14, and the relationship between the alkaline activity values and the α-surface saturation is shown in FIG. 15. The results of FIG. 15 are results obtained by measuring the saturation of the surface of the fiber sheet 1 itself with a saturation meter and results obtained by covering the fiber sheet 1 with a mesh body and measuring the saturation from the top of the mesh body with a saturation meter.

The embodiments of Experimental Examples 7 and 8 conducted using a mesh body are regarded as MA, and the embodiments of Experimental Examples 9 and 10 conducted without using a mesh body are regarded as MB. When measuring the alkaline activity value, a test piece was used in which the center portion of a circularly cut fiber sheet was cut into a size of 10 mm×20 mm.

TABLE 2

| | | Experimental | Experimental | Experimental | Experimental |
|---|---|---|---|---|---|
| | | Example 7 | Example 8 | Example 9 | Example 10 |
| Embodiment | | MA | MA | MB | MB |
| Number of repetitions of dew condensation test | | 4 times | 8 times | 4 times | 8 times |
| Average amount of dew condensation water [mg/cm²] | | 0.65 | 0.63 | 1.56 | 1.39 |
| Saturation | Before test | 26.0 | 26.0 | 26.8 | 26.8 |
| | After test | 22.0 | 20.1 | 21.9 | 11.2 |
| | Maintenance rate [%] | 84.6 | 77.3 | 81.7 | 41.8 |
| Alkaline activity | Before test | 3.3 | 3.3 | 3.3 | 3.3 |
| value | After test | 3.2 | 2.8 | 3.1 | 1.5 |
| | Maintenance rate [%] | 97.0 | 84.8 | 93.9 | 45.5 |

### <Considerations of Dew Condensation Test>

Regarding the average amount of dew condensation water, when comparing the values obtained by the embodiment of MA and the embodiment of MB for the 8th time with each other, the value was significantly low in the embodiment of MA, with an average amount of dew condensation water of (0.63/1.39)×100=about 45%, confirming that dew condensation on the sheet is significantly suppressed. This is thought to be because the ventilation resistance of the mesh body was sufficiently small compared to the outer non-woven fabric cover and the inner fiber sheet, and the mesh body had a certain thickness, and therefore, water vapor from exhaled breath that has passed through the fiber sheet was dispersed in the horizontal direction through the mesh body served as a ventilation layer, creating a new airflow.

Although not conducted in these experimental examples, when a mask is worn on the human body with only a non-woven fabric cover and the antibacterial or antiviral sheet of the present invention without a mesh body, and the condition of the fiber sheet is observed after a certain time in a dew condensation environment of 10° C. or lower, it has become clear that whitening due to dew condensation is concentrated in a narrow area of the fiber sheet (the center portion of the fiber sheet) directly exposed to exhaled breath. This fact also shows that the generation of the dispersed airflow by the mesh body is effective in suppressing dew condensation.

Regarding saturation, no decrease in saturation was observed until the 8th time in the embodiment of MA. On the other hand, on or after the 6th time in the embodiment of MB, a gradual decrease in saturation was observed, and in the 8th time, the maintenance rate of the saturation significantly decreased to 41.8%. The reason for this is thought to be that, as described above, in the embodiment of MA, the dew condensation is unlikely to occur on the sheet surface, and deactivation of alkaline activity is effectively suppressed. In addition, it was observed that the whitening phenomenon associated with the neutralization of this sheet gradually spread from the β-surface (inner side) to the α-surface (outer side). That is, it is thought that a state similar to that when the sheet is actually used in the form of a mask could be reproduced.

Regarding the alkaline activity value, in the embodiment of MA, the maintenance rate was as high as 84.8% even after 8 times, but in the embodiment of MB, the maintenance rate was significantly reduced to 45.5%. Similar to the above, it is thought that, in the embodiment of MA, the dew condensation is unlikely to occur, and deactivation of alkaline activity is effectively suppressed.

In addition, when the correlation between the alkaline activity value and the saturation directly measured on the fiber sheet 1 was confirmed, a nearly linear relationship was observed in the region of the alkaline activity reference value of 1.5 or more.

Furthermore, when comparing the saturation measured directly on the fiber sheet 1 with a saturation meter with the saturation measured from above the mesh body after placing the fiber sheet 1 in the bag-like mesh body 40, in a case where the saturation was measured from above the mesh body 40, the saturation level was divided into two levels: saturation being in a constant range when the alkaline activity value was 2.0 or greater; and saturation being in a constant range when the alkaline activity value was 1.5 or less. That is, with the alkaline activity reference value of 1.5 as a boundary, the former was a blue sign to maintain performance, and the latter was a white sign to indicate a replacement time, whereby the replacement time was more likely to be determined than when the saturation was measured directly on the fiber sheet 1, and a clear replacement sign was obtained.

### DESCRIPTION OF REFERENCE NUMERALS

1 Fiber sheet
3 Strip
7 Bacteria
9 Shikkui particles
20 High-coloration region
22 Low-coloration region
30 Non-woven fabric cover
31 Base fabric
33 Strip
34 Central base fabric
35 Upper base fabric
36 Lower base fabric
39 Recess
40 Mesh body
50 Inner frame
60 Mask
70 Mask
80 Mask

1. An antibacterial or antiviral sheet formed from a fiber sheet carrying shikkui particles and an alkaline indicator.

2. The antibacterial or antiviral sheet according to claim 1,
wherein a ratio (D₁/D₂) of a bulk density (D₁) measured on at least one surface of the fiber sheet to a bulk density (D₂) measured on a cross section at a depth of 55±5 μm from the surface is less than 1.0.

3. The antibacterial or antiviral sheet according to claim 1,
wherein a ratio (S₁/S₂) of a saturation (S₁) measured on at least one surface of the fiber sheet to a saturation (S₂) measured on a cross section at a depth of 55±5 μm from the surface is greater than 1.0.

4. The antibacterial or antiviral sheet according to claim 1,
wherein at least one surface of the fiber sheet is covered with a mesh body.

5. The antibacterial or antiviral sheet according to claim 1,
wherein the alkaline indicator is thymolphthalein.

6. A mask comprising the antibacterial or antiviral sheet according to claim 4, which is used to cover the nose and mouth.

7. A method for using the mask according to claim 6,
wherein a ratio (D₁/D₂) of a bulk density (D₁) measured on at least one surface of the fiber sheet to a bulk density (D₂) measured on a cross section at a depth of 55±5 μm from the surface is less than 1.0, and
wherein at least the surface of the fiber sheet having the bulk density (D₁) is placed on a side opposite to a side that covers the nose and mouth.
